(19) United States
(12) Patent Application Publication
(10) Pub. No.: US 2009/0045927 A1
(43) Pub. Date: Feb. 19, 2009

(54) SYSTEM FOR ALERTING REMOTE VEHICLE OPERATOR OF UNSAFE TRANSPORTATION NETWORK CONDITIONS

(75) Inventor: Michael David Atella, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/839,446

(22) Filed: Aug. 15, 2007

(51) Int. Cl. B60Q 1/00

(52) U.S. Cl. 340/425.5

(57) ABSTRACT

The specification and drawing figures describe and illustrate a system for alerting a remote vehicle operator of unsafe transportation network conditions that includes a mobile wireless communications system. A mobile computing platform is mounted on a remote vehicle and operatively connectable across the mobile wireless communications system. Operator driving data, vehicle data, and transportation network data are collected and stored in the mobile wireless communications system and the mobile computing platform, and may be transmitted across the mobile wireless communications system. At least one program is stored either in the mobile wireless communications system or the mobile computing platform, or both, for using the data to determine a safe route between geographical coordinates along the transportation network. An alarm subsystem notifies the operator of the remote vehicle of unsafe transportation network conditions if the operator of the remote vehicle deviates from the safe route, although the mobile computing platform may not be operating.

### BACKGROUND

1. Field

The system, apparatus and method disclosed, illustrated, and claimed in this document pertain generally to alerting a vehicle operator of unsafe transportation network conditions. More particularly, the new and useful system for alerting a remote vehicle operator of unsafe transportation network conditions provides the vehicle operator a safe route to transit a transportation network by collecting, storing, and merging operator driving data, vehicle data, and transportation network data in a (i) a mobile computing platform capable of determining and monitoring a safe route across a transportation network, and/or (ii) a notification backup subsystem capable of alerting the operator of a remote vehicle that the vehicle has deviated from a safe route determined by a database of truck-safe data available to the operator of the remote vehicle. The system is capable of alerting a remote vehicle operator of any unsafe transportation network conditions before the vehicle and operator are confronted by an unsafe transportation network condition. In addition, the system is capable of sending a notification to a remote vehicle operator of an unsafe transportation network condition, whether or not the mobile computing platform is operating, based on the most current safe route information stored in the database of truck-safe data.

2. Background

Mobile asset management is a major concern in various transportation industries such as trucking, railroad, rental equipment, and similar industries. In the trucking industry, for example, an asset manager may be required to track the status and location of several tractor and trailer assets in a fleet. An asset manager may want to know whether a remote vehicle is in service, where the vehicle is located, what is happening to the vehicle in connection with a wide range of variable considerations an asset manager wants to monitor, and how a remote vehicle operator is reacting to conditions along a transportation network.

To enable an asset manager to monitor a remote vehicle's status and operator driving data, a system for at least two-way communications between one or more customer base stations, such as a vehicle dispatcher or asset manager of a customer, and a remote vehicle, is increasingly in demand. To enhance communications, data development, data storage, and receipt and transmissions of information and reports in connection with remote vehicle status between an asset manager and a remote vehicle, at least one mobile wireless communications system has been developed with several useful features. The mobile wireless communications system allows customers to track and collect vehicle data, operator driving data, and transportation network data; allows communications between a vehicle operator and an asset manager; allows optional communications among vehicle operators and selective communication with third parties; allows an asset manager to monitor various problems confronted by vehicle operators in connection with operation of a remote vehicle along a transportation network; constantly collects, stores and transmits information and data about a vehicle, about a vehicle operator, and about transportation network conditions that in turn may be used either to identify in substantially real time a safe route for transit of a remote vehicle across a transportation network, and to warn a remote vehicle operator in substantially real time of unsafe transportation network conditions.

Thus, demand in the industry now has grown to require new, useful and improved mobile wireless communications features with enhanced capabilities for inter-communication between at least one base station and one or more remote vehicles. An exemplary system is QUALCOMM Incorporated's OMNIVISION™ system (in this document, a “mobile wireless communications system”). Efforts to achieve and ensure communications between and among remote vehicles and asset managers have been enhanced, for example, by including in the mobile wireless communications system a position determining system such as a Satellite Positioning System (SPS).

A mobile wireless communications system also may be in part terrestrial, and may be used either independently of an SPS system, or in conjunction with an SPS system, such as QUALCOMM Incorporated's T2 Untethered TrailerTRACS™ Asset Management System, among others. The T2 system, for example, is capable of processing and managing message traffic at least between a customer and a trailer/container. The T2 system includes QUALCOMM Incorporated software used by the customer and asset manager to receive and send information over the wireless network, and performs a range of additional functions, via the Internet. In addition, a mobile wireless communications system might also use alternative channels of communications allowing use of conventional laptop computers that may not be wireless in operation.

At least one unmet demand of asset managers is for an automated system capable of alerting a remote vehicle operator of imminent unsafe transportation network conditions, whether or not the mobile computing platform of a mobile wireless communications system on a remote vehicle is operating.

Accordingly, a need exists in the industry for a new and useful system for providing, substantially in real time, a fail-safe alarm to warn a remote vehicle operator who has deviated from an previously declared safe route that the vehicle may be proceeding along an unsafe transportation network segment.

### SUMMARY

The apparatus, system, and method disclosed, illustrated, and claimed in this document addresses the above-stated needs by providing a mobile wireless communications system adapted to communicate with a remote vehicle. A mobile computing platform is mounted on the remote vehicle. The mobile wireless communications system and the mobile computing platform are operatively connected. The mobile computing platform is capable of collecting, storing, and transmitting across the mobile wireless communications system a wide range of operator driving data, vehicle data, and transportation network data.

In addition, a position determination transceiver is provided. The position determination transceiver is positioned on the remote vehicle. The position determination transceiver also is operatively connected to the mobile computing platform, and operatively connectable to the mobile wireless communications system. The position determination transceiver is capable of receiving from and transmitting to any number of selected customers and to any number of remote vehicle operators operator driving data, vehicle data, and transportation network data.

The vehicle data, remote vehicle data, operator driving data, and transportation network data may be used in combination to rapidly communicate to the remote vehicle operator a suggested safe route of navigation along a transportation network, and to alert the remote vehicle operator of any unsafe transportation network conditions. Because the mobile wireless communications system is capable of storing in memory modules considerable data, it is capable of rapidly recalculating a safe route based on changing conditions along the transportation network, changing vehicle data, and changing operator data occurring during transit across the transportation network.

As indicated, the mobile wireless communications system and the mobile computing platform include a database of truck-safe data stored in memory that includes safe route information for a vehicle, and in the case of a truck, truck-safe data, pertaining to the transportation network across which an operator and a vehicle may travel. The truck-safe data is compiled from safe route information stored in the mobile wireless communications system that includes the mobile computing platform onboard a vehicle. The safe route information and truck-safe data are updated periodically.

In addition, a wide range and variety of vehicle data may be entered into storage associated with the mobile wireless communications system. As indicated in this document, the vehicle data may be entered by one or more vehicle operators, and by one or more asset managers of a customer. The vehicle data may be entered at the commencement of a vehicle trip, or entered at any point along and during a trip across a transportation network, and such vehicle data may alter the safe route information.

Also, as disclosed and claimed in this document, if a remote vehicle operator is not operating the on-board mobile computing platform, and the vehicle deviates from the immediately preceding safe route provided to the vehicle operator, a fail-safe subsystem of the mobile wireless communications system will notify the operator that the operator will proceed at the operator's peril and the vehicle's peril.

The safe route information may be proprietary to a vehicle owner or manager or to the developer of the mobile wireless communications system. The safe route information also may be provided by software, hardware, and/or a combination of software and hardware provided by third-party providers of digital mapping information such as the non-exclusive examples of NAVTEQ and Maptuit Corporation, companies that provides digital map information for vehicle navigation systems, mobile navigation devices, and Internet-based mapping applications. Safe route information may include numerous details about a transportation network including, as a non-exclusive example, turn restrictions, physical barriers, gates, one-way streets, restricted access including hazard materials (“hazmat”) restrictions, bridge heights, load and/or weight limits, and other information included within the meaning of safe route information and truck-safe route data in this document.

As also indicated, a fail-safe alarm subsystem is included to alert the vehicle operator about unsafe transportation network conditions before the conditions are confronted, based on changing conditions along the transportation network, changing vehicle data, and changing operator data occurring during transit across the transportation network. In one aspect of the invention, the operator of a vehicle may add selected information about the vehicle, a trailer, the operator himself or herself, a proposed transit across a transportation network, and safe route information. The fail-safe alarm system is designed to prompt or notify an operator even if the operator fails to operate the on-board mobile computing platform. If the on-board mobile computing platform is not operating, data previously stored in the on-board mobile computing platform as providing a safe route across one or more segments of a transportation network will be used to alert the remote vehicle operator who deviates from the previously determined safe route that the vehicle operator and vehicle may encounter unsafe transportation network conditions, thus avoiding accidents and personal injuries, and providing increased efficiencies of remote vehicle operation.

Also included is at least one program stored in the system for merging and operating on the data such as operator driving data, vehicle data, and transportation network data to identify in substantially real time a safe route for transit of a remote vehicle across a transportation network, and to warn a remote vehicle operator in substantially real time of unsafe transportation network conditions.

It will become apparent to one skilled in the art that the claimed subject matter as a whole, including the structure of the apparatus, and the cooperation of the elements of the apparatus, combine to result in a number of unexpected advantages and utilities. The structure and co-operation of structure of the system for alerting a remote vehicle operator of unsafe transportation network conditions will become apparent to those skilled in the art when read in conjunction with the following description, drawing figures, and appended claims.

The foregoing has outlined broadly the more important features of the invention to better understand the detailed description that follows, and to better understand the contributions to the art. The system for alerting a remote vehicle operator of unsafe transportation network conditions is not limited in application to the details of construction, and to the arrangements of the components, provided in the following description or drawing figures, but is capable of other embodiments, and of being practiced and carried out in various ways.

The phraseology and terminology employed in this disclosure are for purpose of description, and therefore should not be regarded as limiting. As those skilled in the art will appreciate, the conception on which this disclosure is based readily may be used as a basis for designing other structures, methods, and systems. The claims, therefore, include equivalent constructions. Further, the abstract associated with this disclosure is intended neither to define the system for alerting a remote vehicle operator of unsafe transportation network conditions, which is measured by the claims, nor intended to limit the scope of the claims.

The novel features of the system for alerting a remote vehicle operator of unsafe transportation network conditions are best understood from the accompanying drawing, considered in connection with the accompanying description of the drawing, in which similar reference characters refer to similar parts, and in which:

### BRIEF DESCRIPTION OF THE DRAWING

FIG. 1 of the drawing is a block diagram of the components of a mobile wireless communications system; and

FIG. 2 is a side perspective view of a portion of a vehicle with a mobile computing platform.

To the extent that the numerical designations in the drawing figures include lower case letters such as “a,b” such designations include multiple references, and the letter “n” in lower case such as “a-n” is intended to express a number of repetitions of the element designated by that numerical reference and subscripts.

### DETAILED DESCRIPTION

### Definitions

As used in this document the term “exemplary” means serving as an example, instance, or illustration. Any aspect described in this document as “exemplary” is not intended to mean preferred or advantageous over other aspects of the system.

As used in this document, the term “mobile wireless communications system” means a wireless communications system adapted to communicate with a remote vehicle and includes at least the QUALCOMM® OMNIVISION® system, but also includes any mobile wireless communications system capable of tracking and/or communicating with a vehicle by mobile two-way satellite and/or terrestrial means to enable a customer to monitor several parameters of the remote vehicle, the vehicle operator, and the transportation network.

The term “customer” means a user of the system described, illustrated, and claimed in this document, including subscribers to a mobile wireless communications system, and any agent designated by the subscriber, such as an asset manager and a vehicle operator.

The term “transportation network” means any combination and permutation of a system of transit such as a road and highway system considered part of a means for conveyance or travel from one place to another, often but not always interconnected into a grid or pattern.

As used in this document, the term “vehicle data” means at least information about a vehicle both (i) at commencement of a transit across a transportation network, and (ii) changes in information about a vehicle occurring during transit across a transportation network due, for example, to changed loads, and/or, in the case of trucks, changed tractors, trailers, or containers. Accordingly, “vehicle data” includes, but is not limited to, vehicle dimensions; vehicle weight; vehicle contents; geographical locations across a transportation network as defined by geographic coordinates; proposed interim and final destinations of the remote vehicle within a transportation network; payloads and payload capacity; vehicle and/or vehicle operator licensing certification and licensing certification standards that may change among jurisdictions through which a vehicle may transit and as a truck, tractor and/or container change during transit; proposed interim and final destination of the remote vehicle within a transportation network; and operator driving data, among other information. Vehicle data may be inserted into storage and memory of the system for alerting a remote vehicle operator of unsafe transportation network conditions either automatically as data is acquired by the mobile communications system, by an asset manager of a customer, by data transfer from a mobile wireless communications center, or by an operator of a vehicle.

The term “safe route information” and/or “safe route navigation information” and/or “truck-safe route data” means a recommended transit across a transportation network between geographical coordinates that, based on the vehicle data, operator data, and transportation network data, poses the fewest unsafe transportation network conditions. As is true of vehicle data, safe route navigation information may be inserted into storage and memory of the system for alerting a remote vehicle operator of unsafe transportation network conditions either automatically as data is acquired by the mobile communications system, by an asset manager of a customer, by data transfer from a mobile wireless communications center, or by the operator of a vehicle. Thus, as a minimum, safe route information may include numerous details about a transportation network including, as non-exclusive examples, turn restrictions, physical barriers, gates, one-way streets, restricted access including hazard materials (“hazmat”) restrictions, bridge heights, load and/or weight limits, and at least other information contributing to safe route information and truck-safe route data in this document.

The term “unsafe” as used in connection with “transportation network conditions” means not only dangerous conditions and/or conditions that might cause injury or economic loss, but also conditions along a transportation network that, due to remote vehicle data, a remote vehicle operator likely would want to avoid, including, but not limited to, hazards and restrictions imposed by government authorities.

The term “fail-safe” as used in connection with “subsystem” means a subsystem that substantially automatically notifies a vehicle operator of potential unsafe transportation network conditions, regardless of whether the vehicle operator is operating a mobile wireless communications system.

The term “operator driving data” means information and data that includes at least, but is not limited to, a vehicle operator's history, conduct, health, authorized medicines, and reactions to conditions confronted by the vehicle operator while transiting a transportation network; prior training; licensing; certifications received by the vehicle operator to load, handle, and offload special payloads such as hazardous materials; physical and emotional attributes of a particular driver; learning capabilities and learning curves of a particular driver; driving tendencies and driving reaction tendencies of a particular driver that may be factored into one or more vehicle operator curricula for reducing accidents and personal injuries when operating a remote vehicle on a transportation network, and increasing vehicle operation efficiencies. Operator driving data may be inserted into storage of the system for alerting a remote vehicle operator of unsafe transportation network conditions either automatically as data is acquired by the mobile communications system, by an asset manager of a customer, by data transfer from a mobile wireless communications center, or by the operator of a vehicle.

The term “vehicle” as used in this document means motorized vehicles including trucks, cars, and trains, ships, boats, and the like, as well as other assets such as containers, heavy equipment, and similar assets.

The term “remote” as used in this document means that one object, like a vehicle, is removed in space from another systemically interrelated but distant object or objects like a customer's headquarters, or that one object has the capability of acting on, controlling, sending data to, or acquiring data from, such other systemically interrelated but distant object or objects, without necessarily coming into physical contact with one another.

### DESCRIPTION

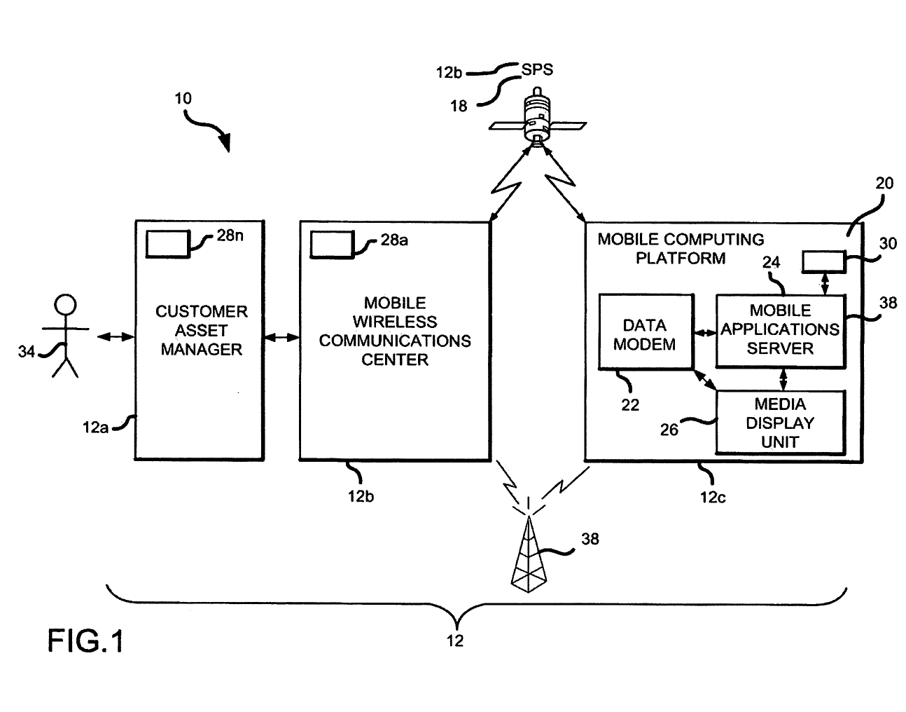

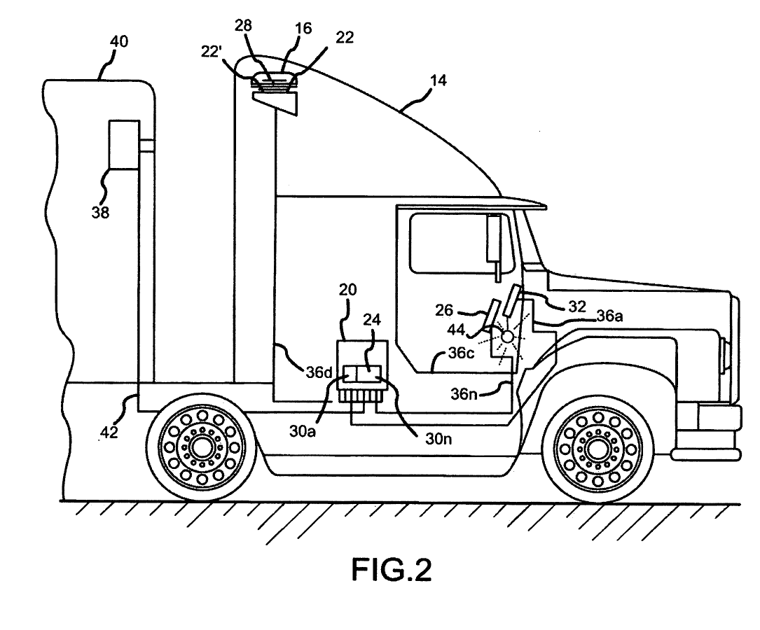

As illustrated in FIGS. 1-2, a system for providing alerting a remote vehicle operator of unsafe transportation network conditions is provided that, in its broadest context, includes a mobile wireless communications system adapted to communicate with a remote vehicle. A mobile computing platform is mounted on the remote vehicle. The mobile wireless communications systems, and the mobile computing platform, are operatively connected. The mobile computing platform is capable of collecting, storing and transmitting across a mobile wireless communications system a wide range of operator driving data, vehicle data, and transportation network data.

In addition, a position determination transceiver, or a position determination receiver and transmitter (collectively, “transceiver”), is provided. The position determination transceiver is positioned on the remote vehicle. The position determination transceiver also is operatively connected to the mobile computing platform, and operatively connectable to the mobile wireless communications system. The position determination transceiver is capable of transmitting to any number of customers, asset managers of customers, and vehicle operators a wide range of operator data, vehicle data, and transportation network data that may be used to identify in substantially real time a safe route for transit of a remote vehicle across a transportation network, and to warn a remote vehicle operator in substantially real time of unsafe transportation network conditions.

Also included is a fail-safe subsystem capable of alerting a remote vehicle operator who deviates from the previously determined safe route that the vehicle operator and vehicle may encounter unsafe transportation network conditions.

More specifically, as illustrated by cross-reference between FIGS. 1-2, a system for alerting a remote vehicle operator of unsafe transportation network conditions 10 includes a mobile wireless communications system 12. The mobile wireless communications system 12 is adapted to communicate with the remote vehicle 14 illustrated in FIG. 2. The mobile wireless communications system 12 may consist of QUALCOMM Incorporated's OMNIVISION®, but may also include QUALCOMM Incorporated's OMNITRACS® and/or T2 Untethered TrailerTRACS™, among others. In one aspect of the system for alerting a remote vehicle operator of unsafe transportation network conditions 10, the mobile wireless communications system 12 also includes a position determination transceiver 16 illustrated in FIG. 2. The position determination transceiver may be part of a Global Positioning System (GPS), a Satellite Positioning System (SPS), or a combination of one or more SPS's and terrestrial systems represented diagrammatically by SPS 18 and 38′ in FIG. 1.

As also illustrated in FIGS. 1 and 2, a system for alerting a remote vehicle operator of unsafe transportation network conditions 10 also includes a mobile computing platform 20. As shown, the mobile computing platform 20 is mounted on the remote vehicle 14. As illustrated by cross-reference between FIGS. 1-2, the mobile computing platform 20 mounted on the remote vehicle 14 is operatively connectable to the mobile wireless communications system 12. The mobile computing platform 20 is capable of storing in memory a wide variety of data and information, including operator driving data, vehicle data, and transportation network data.

In one aspect of the system for alerting a remote vehicle operator of unsafe transportation network conditions 10, the mobile computing platform 20 includes, as shown in FIG. 1, a data modem 22, a mobile applications server 24, and a media display unit 26 mounted on the remote vehicle 14 for viewing a wide range of information and messages by a remote vehicle operator. As illustrated, the data modem 22 is a satellite data modem 22′ mounted on the remote vehicle 14. The satellite data modem 22′ includes at least one antenna 28 capable of receiving and transmitting messages and signals across an SPS system 18 to a plurality of servers 28a-n and the mobile applications server 24 within the mobile wireless communications system 12 as illustrated diagrammatically in FIG. 1. The media display unit 26 may include a full keyboard and/or a laptop computer (not shown), but in any event is intended to be operated either by a second occupant of the remote vehicle 14 during operation of the remote vehicle 14, or by a vehicle operator while the remote vehicle 14 is stationary.

The mobile application server 24 is capable of receipt and transmission of communications, including, as illustrated in FIG. 1, communications received through an SPS system 18 relayed to the satellite data modem 22′ illustrated in FIG. 2. The mobile application server 24 is not limited to the capability described in this document, but may perform such aspects as processing a signal on sensing vehicle misappropriation, as well as a host of other features and performances. The mobile application server 24 also may include a plurality of programmable general-purpose modules 30a-n as illustrated diagrammatically in FIGS. 1-2 capable of at least receiving, storing, and transmitting across the mobile wireless communications system 12 operator driving data, vehicle data, and transportation network data.

The mobile computing platform 20 may also be operatively connected to an optional compact display unit 32, as illustrated in FIG. 2, as well as to a remote control unit (not shown), and at least one speaker (not shown) to enhance receipt and transmission of data and information across the mobile communication system 12. The media display unit 26, and any additional units such as an optional compact display unit 32, enable a vehicle operator and/or a vehicle occupant to communicate with at least one asset manager 34 of a customer as illustrated diagrammatically in FIG. 1. The mobile application server 24 typically is mounted on a remote vehicle 14 within an on-board toolbox behind the vehicle operator's cab, as shown in FIG. 2. As a person skilled in the art will appreciate, the mobile application server 24 is connected by one or more cables 36a-n to the media display unit 26, to the optional compact display unit 32, and to other optional accessories.

As also illustrated in FIG. 1, a substantially terrestrial mobile wireless communications system 38, also capable of processing and managing message traffic at least between a customer asset manager 34 and a trailer/container 40, may also be used for communications across the mobile wireless communications system. As shown, the substantially terrestrial mobile wireless communications system 38 is operatively connected to the mobile computing platform 20 by, for example, a power bus 42 as shown in FIG. 2. The substantially terrestrial mobile wireless communications system 38 is capable of processing not only operator driving data, vehicle data, and transportation network data to a customer in the mobile wireless communications system 12, including an asset manager 34, but also is capable of receiving and displaying information and messages to and from the operator pertaining at least to operator driving data, vehicle data, and transportation network data via the mobile computing platform 20. Accordingly, the mobile wireless communications system 12 and mobile computing platform 20 are capable of collecting, storing, and transmitting operator driving data, vehicle data, and transportation network data.

As will be evident to a person skilled in the art, the mobile computing platform 20 may include one or more programs capable of collecting and collating operator driving data, vehicle data, and transportation network data that may be used in connection with the plurality of general purposes modules 30a-n, the one or more programs associated with the modules, and the combination of operator driving data, vehicle data, and transportation network data, to compile and report to a remote vehicle operator via the media display unit 26 or other component, such as the compact display unit 32, a proposed safe route across one or more transit segments of a transportation network.

A fail-safe alarm subsystem 44, preferably included as a software application stored in the mobile computing platform 12c, as shown in FIG. 1, is provided. The fail-safe alarm subsystem 44 operates to notify a vehicle operator, via the mobile computing platform 12c, and any component of the on-board mobile computing platform 12c, of an unsafe transportation network condition. Although the safe route information portion of the mobile computing platform 12c may not be activated, the fail-safe alarm subsystem 44 provides a notification to the vehicle operator that the remote vehicle 14 has deviated from the most recently identified safe route across the transportation network. The fail-safe alarm subsystem 44 uses the most recent safe route information available to the mobile wireless communications system 12. As indicated, the fail-safe alarm system is intended to be shown diagrammatically, and the symbol used in the drawing figures is not limited to any specific apparatus or device for alerting the vehicle operator about an unsafe transportation network condition. Indeed, the alert may arise from apparatus and methods already included in the mobile computing platform 12c, without the need for an add-on apparatus or device.

The mobile wireless communications system 12 is a valuable, if not necessary, tool for an asset manager 34 and a remote vehicle operator, but obviously only if a remote vehicle operator activates operation of the on-board mobile computing platform 20 and its associated components. If, however, the remote vehicle operator does not activate operation of the on-board mobile computing platform 20 and its associated components, many of the desirable safety attributes and features of the mobile wireless communications system 12 are not achieved. The data and information derived from the operator driving data, vehicle data, and transportation network data would be available across the mobile wireless communications system 12, but the information about changed or changing transportation network conditions would not be available to alert the remote vehicle operator about unsafe transportation network conditions.

The fail-safe alarm subsystem 44 is capable of alerting a remote vehicle operator of unsafe transportation network conditions although the remote vehicle operator does not activate operation of the on-board mobile computing platform 20 and its associated components. A signal from the fail-safe alarm subsystem 44 alerts the remote vehicle operator about unsafe transportation network conditions aurally, visually, and/or textually. The one or more programs associated with the fail-safe alarm subsystem 44 are stored in the one or more modules 30a-n. The one or more programs substantially continuously are backed-up with data and information derived from the operator driving data, vehicle data, and transportation network data. The one or more programs are designed to store the safe route information calculated by the mobile computing platform 20 and stored in the mobile applications server 24. If transportation network conditions change, or are about to change, creating an unsafe transportation network condition, the fail-safe alarm subsystem 44 alerts the remote vehicle driver about the problem. The alert has the salutary effect of informing the operator of a remote vehicle who may have forgotten to activate operation of the mobile computing platform 20 that the mobile computing platform 20 should be activated.

Those of skill in the art will also appreciate that the various illustrative logical blocks, modules, circuits, and algorithm steps described in connection with the aspects disclosed in this document may be implemented as electronic hardware, computer software, or combinations of both. To clearly illustrate this interchangeability of hardware and software, various illustrative components, blocks, modules, circuits, and steps have been described in this document generally in terms of their functionality. Whether such functionality is implemented as hardware or software depends on the particular application and design constraints imposed on an overall system. Skilled artisans may implement the described functionality in varying ways for each particular application, but such implementation decisions should not be interpreted as causing a departure from the scope of the present invention.

The various illustrative logical blocks, modules, and circuits described in connection with the aspects disclosed in this document: may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination designed to perform the functions described in this document. A general-purpose processor may be a microprocessor, but in the alternative, the processor may be any conventional processor, controller, microcontroller, or state machine. A processor may also be implemented as a combination of computing devices such as, in a non-exclusive example, a combination of a DSP and a microprocessor, a plurality of microprocessors, one or more microprocessors in conjunction with a DSP core, or any other such configuration.

One or more algorithms associated with the mobile computing platform 20 illustrated in this document may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor so the processor may read information from, and writes information to, the storage medium. In the alternative, the storage medium may be integral to the processor. The processor and the storage medium may reside in an ASIC. An ASIC, if used, may reside in the mobile computing platform 20. In the alternative, the processor and the storage medium may reside as discrete components in any component of the mobile computing platform 20.

Any machine-readable medium tangibly embodying instructions may be used in implementing the methodologies described in this document. As a non-exclusive example, software codes may be stored in a memory or database or storage unit, and executed by a processor, for example a microprocessor of the mobile applications server 24. Memory may be implemented within the processor or external to the processor. As used in this document, the term “memory” refers to any type of long term, short term, volatile, nonvolatile, or other memory and is not to be limited to any particular type of memory or number of memories, or type of media upon which memory is stored.

The description of the disclosed aspects is provided to enable any person skilled in the art to make or use the apparatus, system, and method disclosed, illustrated and claimed in this document. Various modifications to these aspects will be readily apparent to those skilled in the art, and the generic principles defined in this document may be applied to other aspects without departing from the spirit or scope of the system for providing individualized training curricula to vehicle operator. Thus, the invention is not intended to be limited to the aspects shown in this document, but is intended to be accorded the widest scope consistent with the principles and novel features disclosed in this document.

The method and apparatus described in this document may be used with various satellite positioning systems (SPS), such as the United States Global Positioning System (GPS), the Russian Glonass system, the European Galileo system, any system that uses satellites from a combination of satellite systems, or any satellite system developed in the future. Furthermore, the disclosed method and apparatus may be used with positioning determination systems that utilize pseudolites or a combination of satellites and pseudolites. Pseudolites are ground-based transmitters that broadcast a PN code or other ranging code similar to a GPS or CDMA cellular signal, modulated on an L-band or other frequency carrier signal, which may be synchronized with GPS time. Each such transmitter may be assigned a unique PN code to permit identification by a remote receiver. Pseudolites are useful in situations where GPS signals from an orbiting satellite might be unavailable, as in tunnels, mines, buildings, urban canyons or other enclosed areas. Another implementation of pseudolites is known as radio beacons. The term “satellite,” as used herein, is intended to include pseudolites, equivalents of pseudolites, and possibly others. The term “SPS signals”, as used in this document, is intended to include SPS-like signals from pseudolites or equivalents of pseudolites.

Claim elements and steps in this document have been numbered solely as an aid in understanding the description. The numbering is not intended to, and should not be considered as intending to, indicate the ordering of elements and steps in the claims. In addition, the system for providing individualized training curricula to a vehicle operator 10 shown in drawing FIGS. 1 through 2 shows at least one aspect of the system for providing individualized training curricula to a vehicle operator, not intended to be exclusive, but merely illustrative of the disclosed embodiments. Also, method steps may be interchanged sequentially without departing from the scope of the invention. Means-plus-function clauses in the claims are intended to cover the structures described as performing the recited function that include not only structural equivalents, but also equivalent structures.

What is claimed is:

1. A system for alerting a remote vehicle operator of unsafe transportation network conditions, comprising:
a mobile wireless communications system adapted to communicate with the remote vehicle,
wherein the mobile wireless communications system includes a mobile computing platform mounted on the remote vehicle and operatively connectable across the mobile wireless communications system, the mobile computing platform adapted to store at least vehicle data;
a safe route navigation program operatively connected to the mobile computing platform adapted to collect, store, and transmit safe route navigation information across the transportation network responsive to the remote vehicle data; and
a fail-safe alarm subsystem operatively connected to the mobile computing platform adapted to alert the remote vehicle operator about unsafe transportation network conditions whether or not the mobile computing platform is operating.

2. A system for alerting a remote vehicle operator of unsafe transportation network conditions as recited in claim 1, wherein the mobile wireless communications system is selected from a group of mobile wireless SPS communications systems and/or mobile wireless terrestrial systems.

3. A system for alerting a remote vehicle operator of unsafe transportation network conditions as recited in claim 1, wherein the mobile wireless communications system is selected from a group of mobile wireless communications systems consisting of QUALCOMM® OMNIVISION® and/or QUALCOMM® OmniTRACS® and/or QUALCOMM® T2 System, among others.

4. A system for alerting a remote vehicle operator of unsafe transportation network conditions as recited in claim 1, further comprising a position determination transceiver mounted on the remote vehicle adapted to at least determine the transceiver's location, speed, and direction.

5. A system for alerting a remote vehicle operator of unsafe transportation network conditions as recited in claim 3, wherein the position determination transceiver is a Global Positioning System (GPS) or Satellite Positioning System (SPS) or a combination of one or more SPS's, and/or a combination of one or more transceivers operatively connectable to the mobile computing platform.

6. A system for alerting a remote vehicle operator of unsafe transportation network conditions as recited in claim 1, wherein the mobile computing platform includes memory located in the mobile computing platform for storing at least safe route navigation information.

7. A system for alerting a remote vehicle operator of unsafe transportation network conditions as recited in claim 1, wherein the mobile computing platform includes a media display unit adapted to allow a remote vehicle operator to view, respond to, and transmit vehicle data across the mobile wireless communications system.

8. A system for alerting a remote vehicle operator of unsafe transportation network conditions as recited in claim 7, wherein the media display unit provides notification to the remote vehicle operator that the remote vehicle has deviated from a safe route.

9. A system for alerting a remote vehicle operator of unsafe transportation network conditions as recited in claim 7, wherein the media display unit provides notification to the remote vehicle operator that the remote vehicle has deviated from a safe route, the notification occurring although the mobile computing platform is not operating.

10. A system for alerting a remote vehicle operator of unsafe transportation network conditions as recited in claim 1, wherein the fail-safe alarm subsystem alerts the remote vehicle operator audibly, visually, and/or textually.

11. An apparatus for improving vehicle operator safety, comprising:
a mobile wireless communications system;
a mobile communications platform operatively connectable to the mobile wireless communications system capable of collecting, storing, and transmitting across the mobile wireless communications system operator driving data, vehicle data, and transportation network data;
means for providing the vehicle operator a safe route across the transportation network; and
means for notifying the operator of unsafe transportation network conditions if the mobile communications platform is not operational.

12. An apparatus for improving vehicle operator safety as recited in claim 10, wherein the operator driving data, vehicle data, and transportation network data is collected and stored in the mobile computing platform during transit of the vehicle across a transportation network.

13. An apparatus for improving vehicle operator safety as recited in claim 12, wherein the operator driving data, vehicle data, and transportation network data is collected, stored and transmitted by the mobile wireless communications system.

14. An apparatus for improving vehicle operator safety as recited in claim 13, wherein the means for providing the vehicle operator a safe route across the transportation network is safe route navigation data.

15. An apparatus for improving vehicle operator safety as recited in claim 14, wherein the safe route navigation data compares the operator driving data, vehicle data, and transportation network data to derive the safest route between transit segments of a transportation network system.

16. An apparatus for improving vehicle operator safety as recited in claim 15, wherein the means for notifying the operator of unsafe transportation network conditions if the mobile communications platform is not operating is a notification communicable to the vehicle operator.

17. An apparatus for improving vehicle operator safety as recited in claim 15, wherein the notification communicable to the vehicle operator is provided aurally, visually, and/or textually.

18. A method of alerting a vehicle operator of unsafe transportation network conditions, comprising the steps of:
providing a mobile wireless communications system that includes a mobile computing platform mounted in the vehicle;
installing in the mobile wireless communications system and/or the mobile computing platform one or more computer components capable of collecting, storing, and transmitting operator driving data, vehicle data, and transportation network data;
comparing the operator driving data, vehicle data, and transportation network data to determine a safe route across a transportation network; and
including a subsystem for alerting the operator of any unsafe transportation network conditions even when the mobile computing platform is not operating.

19. A method of alerting a vehicle operator of unsafe transportation network conditions as recited in claim 18, wherein the step of providing a mobile wireless communications system includes the substeps of selecting a mobile wireless communications system from a group of mobile wireless communications systems consisting of QUALCOMM® OMNIVISION® and/or QUALCOMM® OmniTRACS® and/or QUALCOMM® T2 System, among others.

20. A method of alerting a vehicle operator of unsafe transportation network conditions as recited in claim 18, wherein the step of providing a mobile wireless communications system that includes a mobile computing platform mounted in the vehicle includes the substep of connecting operatively the mobile computing platform to the mobile wireless communications system with a position determination system such as a Global Positioning System (GPS) or Satellite Positioning System (SPS) and/or a combination of one or more SPS's, and/or one or more terrestrial systems.

21. A method of alerting a vehicle operator of unsafe transportation network conditions as recited in claim 18, wherein the step of including a device for alerting the operator of any unsafe transportation network conditions includes the substeps of notifying the operator aurally, visually, and/or textually.
